(19) United States
(12) Patent Application Publication
(10) Pub. No.: US 2008/0101663 A1
(43) Pub. Date: May 1, 2008

(54) METHODS FOR GRAY-LEVEL RIDGE FEATURE EXTRACTION AND ASSOCIATED PRINT MATCHING

(75) Inventors: PETER Z. LO, LAKE FOREST, CA (US); BEHNAM BAVARIAN, NEWPORT COAST, CA (US); YING LUO, IRVINE, CA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/554,861

(22) Filed: Oct. 31, 2006

(51) Int. Cl. G06K 9/00

(52) U.S. Cl. 382/124

(57) ABSTRACT

A method for level three feature extraction from a print image extracts features associated with a selected ridge segment using a gray-level image under the guidance of at least one binary image. The level three features are a sequence of vectors each corresponding to a different level three characteristic and each representing a sequence of values at selected points on a print image. The level three features are stored and used for level three matching of two prints. During the matching stage, ridge segments are correlated against each other by shifting or a dynamic programming method to determine a measure of similarity between the print images.

### TECHNICAL FIELD

The present invention relates generally to print feature extraction and matching and more specifically to gray-level ridge feature extraction and associated print matching using the extracted gray-level features.

### BACKGROUND

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage and the second is the identification stage. In the registration stage, the register's prints (as print images) and personal information are enrolled, and features, such as minutiae, are extracted. The personal information and the extracted features are then used to form a file record that is saved into a database for subsequent print identification. Present day automatic fingerprint identification systems (AFIS) may contain several hundred thousand to a few million of such file records. In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of matched scores is generated after the matching process. Candidate records are sorted according to matched scores. A matched score is a measurement of the similarity of the print features of the identified search and file records. The higher the score, the more similar the file and search records are determined to be. Thus, a top candidate is the one that has the closest match.

However it is well known from verification tests that the top candidate may not always be the correctly matched record because the obtained print images may vary widely in quality. Smudges, individual differences in technique of the personnel who obtain the print images, equipment quality, and environmental factors may all affect print image quality. To ensure accuracy in determining the correctly matched candidate, the search record and the top “n” file records from the sorted list are provided to an examiner for manual review and inspection. Once a true match is found, the identification information is provided to a user and the search print record is typically discarded from the identification system. If a true match is not found, a new record is created and the personal information and print features of the search record are saved as a new file record into the database.

Many solutions have been proposed to improve the accuracy of similarity scores and to reduce the workload of manual examiners. These methods include: designing improved fingerprint scanners to obtain better quality print images; improving feature extraction algorithms to obtain better matching features or different features with more discriminating power; and designing different types of matching algorithm from pattern based matching to minutiae and texture based matching, to determine a level of similarity between two prints.

Among these technologies, high resolution imaging techniques provide great opportunities to improve the accuracy of the AFIS. Today, high-resolution fingerprint sensors have been gradually adopted in the industry and compatibility to high-resolution images has been implemented. However, current feature extraction and print matching techniques fail to take advantage of additional print detail captured in high resolution images. For example, the so-called “level-three features” including, but not limited to, pores on friction ridges, ridge gray-level distribution, ridge shape and incipient ridges, are very rich in high-resolution images, but are not currently used in the AFIS for two primary reasons. The first reason is that these features are not reliable enough in low-resolution images for computer processing. Second, even if these features are reliably imaged in high-resolution images, current feature extraction techniques cannot be effectively used to extract such features for later use in print matching.

Thus, what is need are techniques to efficiently extract level-three features from high resolution images and use the extracted features to improve the accuracy of print matching in, for example, the AFIS.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of an AFIS implementing embodiments of the present invention.

FIG. 2 is a flow diagram illustrating a method for print image feature extraction in accordance with an embodiment of the present invention.

FIG. 3 is a flow diagram illustrating a method for print image feature extraction in accordance with an embodiment of the present invention.

FIG. 4 demonstrates ridge feature determination from a ridge segment portion in accordance with an embodiment of the present invention.

FIG. 5 demonstrates a method for storing feature vectors of three associated ridge segments for a bifurcation in accordance with an embodiment of the present invention.

FIG. 6 is a flow diagram illustrating a method for comparing a search and file print image using gray-level ridge features, in accordance with an embodiment of the present invention.

FIG. 7 is a flow diagram illustrating a method for comparing a search and file print image using gray-level ridge features, in accordance with an embodiment of the present invention.

FIG. 8 illustrates the matching of two ridge feature vectors using correlation in accordance with an embodiment of the present invention.

FIG. 9 illustrates the matching of two ridge feature vectors using dynamic programming.

### DETAILED DESCRIPTION

Before describing in detail embodiments that are in accordance with the present invention, it should be observed that the embodiments reside primarily in combinations of method steps and apparatus components related to a method and apparatus for gray-level ridge feature extraction and associated print matching. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for gray-level ridge feature extraction and associated print matching described herein. The non-processor circuits may include, but are not limited to, a radio receiver, a radio transmitter and user input devices. As such, these functions may be interpreted as steps of a method to perform the gray-level ridge feature extraction and associated print matching described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device and a magnetic storage device. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, level-three features are extracted from high-resolution print images and those features are used in a print matching process to improving matching accuracy. Those skilled in the art will realize that the above recognized advantages and other advantages described herein are merely exemplary and are not meant to be a complete rendering of all of the advantages of the various embodiments of the present invention.

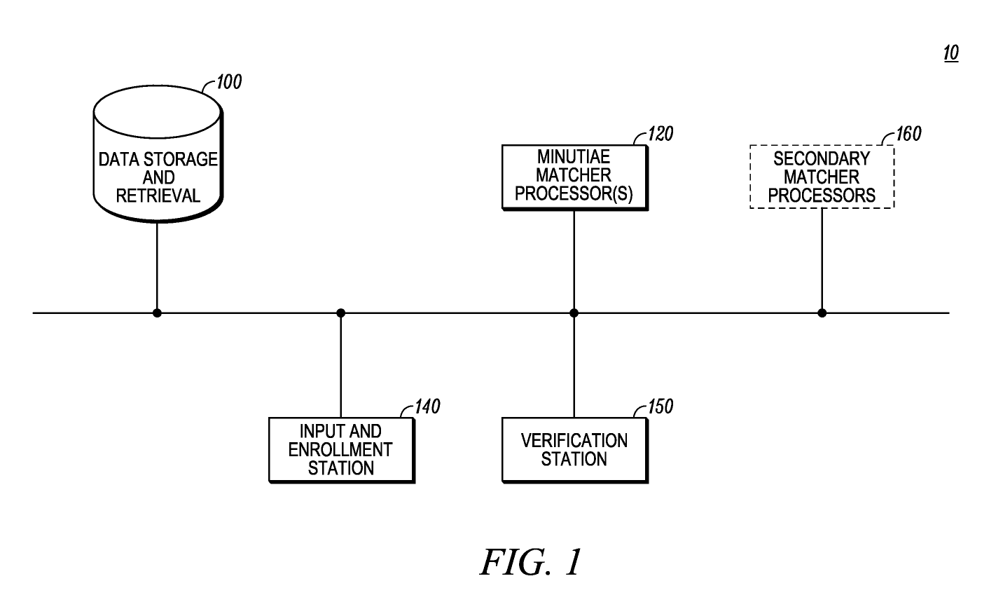

Referring now to the drawings, and in particular FIG. 1, a logical block diagram of an exemplary fingerprint matching system implementing embodiments of the present invention is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe and palm prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print image or a known ten-print) to a database of file print records (e.g., that contain ten-print records of known persons) and identifies one or more candidate file print records that match the search print record. The ideal goal of the matching process is to identify, with a predetermined amount of certainty and without a manual visual comparison, the search print as having come from a person who has print image(s) stored in the database. At a minimum, AFIS system designers and manufactures desire to significantly limit the time spent in a manual comparison of the search print image to candidate file print images (also referred to herein as respondent file print images).

Before describing system 100 in detail, it will be useful to define terms that are used herein.

A print is a pattern of friction ridges (also referred to herein as “ridges”), which are raised portions of skin, and valleys between the ridges on the surface of a finger (fingerprint), toe (toe print) or palm (palm print), for example.

A print image is a visual representation of a print that is stored in electronic form.

A gray scale image is a data matrix that uses values, such as pixel values at corresponding pixel locations in the matrix, to represent intensities of gray within some range. An example of a range of gray-level values is 0 to 255.

Image binarization is the process of converting a gray-scale image into a “binary” or a black and white image. A thin image is a binary image that is one pixel wide. A wide binary image is a binary image that preserves at least the shape and width of ridges and the shape of pores.

A pore is a sweat pore inside the skin, which appear as a white dot on a ridge in a fingerprint image.

A minutiae point or minutiae is a small detail in the print pattern and refers to the various ways that ridges can be discontinuous. Examples of minutiae are a ridge termination or ridge ending where a ridge suddenly comes to an end and a ridge bifurcation where one ridge splits into two ridges.

A similarity measure is any measure (also referred to herein interchangeable with the term score) that identifies or indicates similarity of a file print to a search print based on one or more given parameters.

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise.

A direction field measure or value is the direction assigned to a point (e.g., a pixel location) or block on the direction field image and can be represented, for example, as a slit sum direction, an angle or a unit vector.

A pseudo-ridge is the continuous tracing of direction field points, where for each point in the pseudo-ridge, the tracing is performed in the way that the next pseudo-ridge point is always the non-traced point with smallest direction change with respect to the current point or the several previous points.

A singularity point is a core or a delta.

In a fingerprint pattern, a core is the approximate center of the fingerprint pattern on the most inner recurve where the direction field curvature reaches the maximum.

According to ANSI-INCITS-378-2004 standard, a delta is the point on a ridge at or nearest to the point of divergence of two type lines, and located at or directly in front of the point of divergence.

Level-three features are defined for fingerprint images, for example, relative to level-one and level-two features. Level-one features are the features of the macro-scale, including cores/deltas. Level-two features are the features in more detail, including minutiae location, angles, ridge length and ridge count. Level-three features are of the micro-scale, including pores, ridge shape, ridge gray level distribution and incipient ridges. In comparison to level-one and level-two features which are widely available in current fingerprint images, level-three features are most reliably seen in high resolution, e.g., ≧1000 ppi (pixels per inch) images.

Turning again to FIG. 1, an AFIS that may be used to implement the various embodiments of the present invention described herein is shown and indicated generally at 10. System 10 includes an input and enrollment station 140, a data storage and retrieval device 100, one or more minutiae matcher processors 120, a verification station 150 and optionally one or more secondary matcher processors 160.

The input and enrollment station 140 may be configured for implementing the various feature extraction embodiments of the present invention in any one or more of the processing devices described above. More specifically, input and enrollment station 140 is used to capture fingerprint images to extract the relevant features (minutiae, cores, deltas, binary image, ridge features, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments of the present invention. Minutiae matcher processors 120 compare the extracted minutiae of two fingerprint images to determine similarity. Minutiae matcher processors 120 output to the secondary matcher processors 160 at least one set of mated minutiae corresponding to a list of ranked candidate records associated with minutiae matcher similarity scores above some threshold. Secondary matcher processors 160 provide for more detailed decision logic using the mated minutiae and usually some additional features to output either a sure match (of the search record with one or more print records) or a list of candidate records for manual comparison by an examiner to the search record to verify matching results using the verification station 150. Embodiments of the present invention may be implemented in the minutiae and/or secondary matcher processors, which in turn can be implemented using one or more suitable processing devices, examples of which are listed above.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

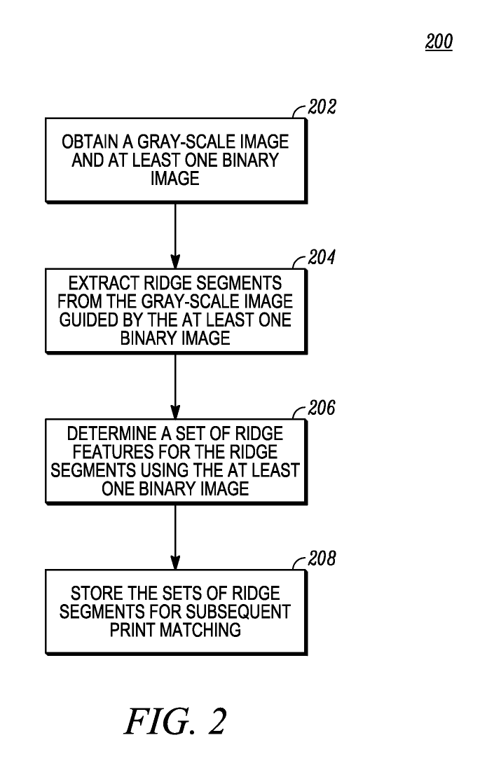

Turning now to FIG. 2, a high-level flow diagram illustrating an exemplary method of feature extraction from a print image in accordance with an embodiment of the present invention is shown and generally indicated at 200. It is appreciated that the method may be implemented in biometric image enrollment for different types of prints such as, for instance, fingerprints, palm prints or toe prints without loss of generality. Thus, all types of prints and images are contemplated within the meaning of the terms “print” and “fingerprint” as used in the various teachings described herein. In general, method comprises the steps of: obtaining (202) a gray-scale image and at least one binary image, which were generated based on a print image (e.g., a fingerprint image, palm print image or toe print image) comprising a plurality of minutiae; relative to each of a plurality of reference points, extracting (204) at least one corresponding ridge segment from the gray-scale image guided by the at least one binary image, with the segment being extracted along an axis of an elongated shape of a ridge that represents a raised portion of skin; determining (206), using the at least one binary image, a corresponding set of ridge features associated with the extracted ridge segment; and storing (208) the sets of ridge features to use in comparing the print image to another print image.

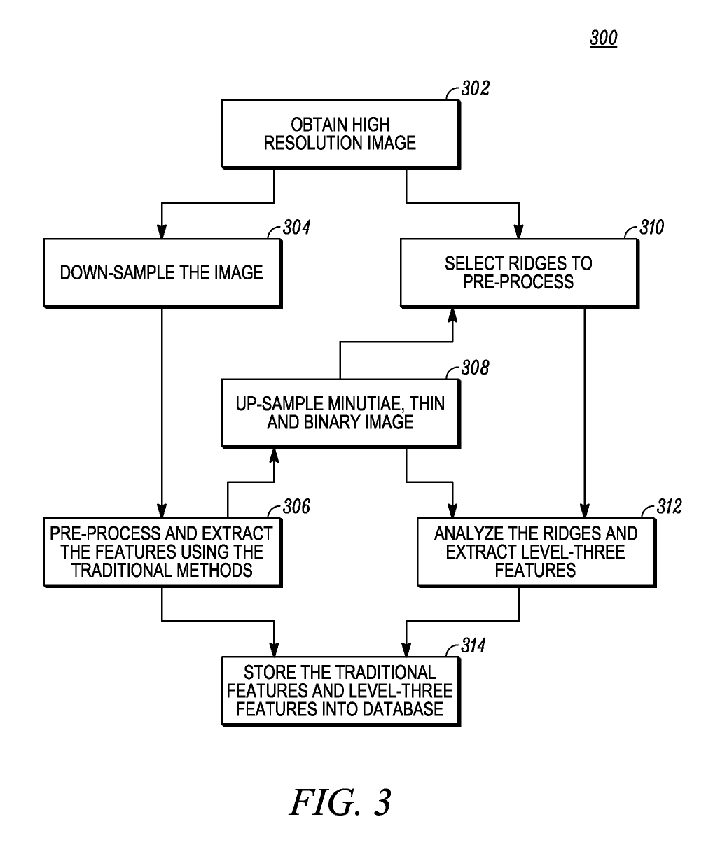

In FIG. 3, a flow diagram of a more detailed method 300 for implementing the steps of method 200 is shown. This method includes the beneficial implementation details that were briefly mentioned above. Moreover, method 300 (and additional methods described below) is described in terms of a fingerprint identification process (such as one implemented in the AFIS shown in FIG. 1) for ease of illustration. However, it is appreciated that the method may be similarly implemented in biometric image enrollment for other types of prints such as, for instance, palm prints or toe prints without loss of generality, which are also contemplated within the meaning of the terms “print” and “fingerprint” as used in the various teachings described herein.

An overview of method 300 will first be described, followed by a detailed explanation of an exemplary implementation of method 300 in an AFIS. In general since the level-three features are extracted based on fingerprint ridges, both how to select the ridges (also referred to as a ridge segment since it is generally associated with a given length) as well as how to extract the level-three features from the selected ridges of a fingerprint image are explained below. The selection of ridges can be very versatile. Ridges can be selected relative to a “reference” point in the fingerprint image based on a number of criterion. For instance, ridges can be selected that are with a certain distance (determined experimentally) of minutiae points, cores, delta or any other point on the fingerprint image having quality that exceeds a certain threshold, which is determined experimentally through empirical data. When minutiae points are used as the reference point for instance, one corresponding ridge is selected relative to a ridge ending. Whereas, three ridges are selected relative to a bifurcation.

The length (or range) of the ridge can be of either a fixed-length or a variable length. Fixed-length ridge range selection is straightforward, since a pre-determined fixed ridge length is ideally given to every selected ridge. The fixed length is determined in one implementation based on the average image quality of the problem data set and can be set to 48 (or 96) for low quality data set and 96 (or 192) for high quality data set, for instance. For variable-length ridge selection, the range of each selected ridge is determined by local characteristics of the fingerprint image relative to the ridge. For example, the range can be determined between two minutia with one minutiae located at one end of the ridge segment and another minutiae located at the other end. Ridge length can be further based on other parameters including, but not limited to, a quality measurement of the ridge (measured by image quality) as compared to a quality threshold determined experimentally. Once ridge segments having the desired range are selected, a set of associated ridge features is extracted, for example, in accordance with exemplary method 300. In this embodiment, the ridge features are based on one or more or the following factors: pores detected on ridge segments in the fingerprint image; shape associated with a ridge segments; and gray-level distribution associated with the ridge segments.

More specifically, a high resolution image, e.g., a gray-scale image, is received at a step 302 into the AFIS via any suitable interface. For example, the fingerprint image can be captured from someone's finger using a high resolution image sensor coupled to the AFIS. The fingerprint image is stored electronically in the data storage and retrieval unit 100. A “high resolution” image is of a sufficient resolution to enable the detection and extraction of the level three features. Usually such images have at least 1000 dpi, but images of lower resolution are anticipated within the scope of the teachings herein. To facilitate reliable and more efficient “traditional” feature extraction and image binarization, the high resolution image is optionally down-sampled to a lower resolution image (e.g., 500 ppi) at a step 304. Registration and image pre-processing is performed using the lower resolution image (step 306). The down sample rate is determined by the image processing and feature extraction algorithm used.

Accordingly, traditional features (other than the ridge features) such as minutiae points, cores and deltas (and any other features needed for level one and/or level two matching) are extracted using any suitable feature extraction algorithms. Moreover, at least one binary image is generated, which in this implementation is a wide binary image and a thin image. The wide binary image maintains characteristics of the gray-scale image, such as ridge shape and width and pore shape. The thin image is extracted from the binary image and is one pixel wide. All of the extracted features and the binary images are up-sampled (at a step 308) to original resolution and used as needed or desired for ridge feature selection and extraction (at steps 310 and 312) in accordance with the teachings herein. All of the features and the binary images extracted at steps 306 and 312 are further stored (at a step 314) in a suitable database for use in level one and two matching such as, for instance, classification filters based on print type and minutiae matching.

Steps 310 and 312 can be performed, for example, as follows to extract the ridge features. In general, a set of ridge features for each extracted ridge segment is determined using corresponding thin and wide ridge segments and comprises a sequence of vectors. Each vector sequence is associated with a different ridge characteristic, and each vector in the sequence includes a corresponding ridge characteristic value at each of a plurality of selected points on the ridge segment. In this implementation, the sequence of vectors comprises: a vector comprising a curvature value at each of the plurality of selected points on the ridge segment; a vector comprising a mean gray level value at each of the plurality of selected points on the ridge segment; a vector comprising a gray level variance value at each of the plurality of selected points on the ridge segment; a vector comprising a pore width value at each of the plurality of selected points on the ridge segment; and a vector comprising a ridge width value at each of the plurality of selected points on the ridge segment.

To initiate ridge segment extraction, any suitable image processing filter (including, but not limited to, a median filter) that does not distort the ridge and pore structure can optionally be used to enhance pores and edges of ridges. Select a reference point from the set of reference points (e.g., a minutia point) relative to which an associated ridge segment is extracted. From the thin image and wide binary image, find the thin ridge and wide binary ridge that is associated with this minutia. Accordingly, starting from the minutiae point (or some other suitable point a distance from the minutiae point) select points in the thin image along the thin ridge (e.g., along an axis of elongated shape) until the desired length L is reached (e.g., until the end of a fixed-length, until another minutia point is reached, etc.). In one implementation, the quality of each selected point exceeds a pre-defined threshold qₜ as determined experimentally. For every point traced on the ridge, calculate normal direction and curvature at that point using any suitable means such as, for instance, by fitting an algebraic curve to the point set around the specific point and calculating the normal direction and Gaussian curvature based on the algebraic curve. Store the curvature at each point as a vector Vᵢ(0).

Next, find the boundary of the wide binary ridge according to the crossing points between the normal line and binary ridge. Obtain the binary ridge width W at this point. From the binary ridge boundaries, extend W/C pixels outward into the valley at both sides and calculate the mean and variance of the whole range of ridge and valley gray-level values at least along the normal line, where C is a predefined value according to the image resolution. This is the mean Mₒ and variance Vₒ of the gray-level ridge at the selected point.

Normalize the corresponding ridge and valley area defined above using the following equation (1):

$${I}_{n} ( x , y ) = \{ \begin{matrix}{M}_{n} + \sqrt{\frac{{V}_{n} \times {( I ( x , y ) - {M}_{o} )}^{2}}{{V}_{o}}} , & if I ( x , y ) > {M}_{o} \\ {M}_{n} - \sqrt{\frac{{V}_{n} \times {( I ( x , y ) - {M}_{o} )}^{2}}{{V}_{o}}} , & otherwise\end{matrix} \qquad ( 1 )$$

where Iₙ(x,y) is the normalized ridge point intensity. Mₙ and Vₙ are the desired mean and variance, and I(x,y) is the original ridge point intensity. Along the normal direction of each point on the thin ridge, take the normalized ridge gray-level profile from the corresponding ridge and valley area using equation (2) and stored the set of calculated mean and variance value corresponding to the points on the thin ridge segment, respectively, as vectors Vᵢ(1) and Vᵢ(2). Finally, find the gray level ridge width and pore width at each selected point on the thin image. First, on the gray-scale image, detect the zero crossing points relative to Mₙ, and based on the analysis of the number of zero crossing points, the crossing direction (from high gray level to low or vice versa) and the distance between the crossing points, find the gray level ridge width and pore width.

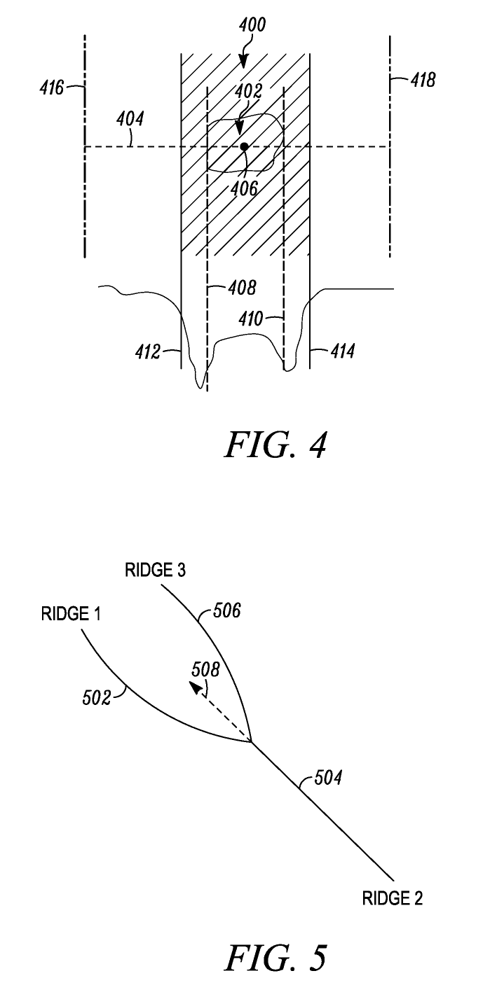

FIG. 4 illustrates a portion of a ridge segment 400 on a gray-scale image, which includes a pore 402. Further shown is a dotted line 404 (normal to the thin ridge (not shown)) along which the normalized ridge gray level profile and corresponding mean and variance, pore width and ridge width for a reference point 406 is determined. The crossing points of dotted lines 404, 408 and 410 are used to determine a width of pore 402 associated with point 406. The crossing points of lines 404, 412 and 414 are used to determine ridge width associated with point 406. Dotted lines 416 and 418 show line 404 being extended from the boundaries of the ridge outward into the valley by W/C pixels as used above to determine the ridge features.

The following exemplary logic can be used for the analysis to find the gray level ridge width and pore width. If the number of crossing points is zero and one, set the gray level ridge width to be the wide binary ridge width, and set the pore width to zero. If the number of crossing points is two, and if the distance between these two points is greater than a threshold determined experimentally, use the gray level ridge width. Otherwise, the gray level ridge width is set by the wide binary ridge width, and the pore width is set to zero (or some minimum value). If the number of crossing points is three, among the first and last crossing point, find the one crossing from high gray level to low gray level. The distance between this point and the middle point is the gray level ridge width, and set the pore width to zero. If the number of crossing points is four, if the crossing direction at the first and last point is from high gray level to low gray level, the distance between the first point and last point is the gray level ridge width, and the distance between two middle points is the pore width. Otherwise, the distance between two middle points is the gray level ridge width, and set the pore width to be zero in this case. If the number of crossing points is greater than four, prune the outmost points gradually until four points are left, and obtain the gray level ridge width and pore width according to the previous logic. Store the gray level ridge width and pore width values, respectively, as vectors Vᵢ(3) and Vᵢ(4).

Repeat the above process for each reference point associated ridge segment to extract the ridge features. Thus, the set of ridge features for each extracted ridge segment comprises the sequence of vectors Vᵢ(0,) Vᵢ(1), Vᵢ(2,), Vᵢ(3) and Vᵢ(4) for each reference point i. As mentioned above, each ridge ending has one associated ridge segment, and each bifurcation normally has three associated ridge segments. Moreover, for each bifurcation point the feature vector sequences can be stored in the following exemplary manner, wherein the ridges (502, 504, 506) are stored following the anti-clockwise directional order starting from the bifurcated ridge (502) that is on the first anti-clockwise position of the minutia direction 508 as shown in FIG. 5. This storage scheme implicitly applies a local coordinate system with the bifurcation ridge as the x axis. This will allow a natural one-to-one ridge matching between two bifurcation minutiae based on their implicit coordinate systems, i.e., the storage ordering. Thus, storing the bifurcation ridges in this foxed order eliminates the need to mate ridges at the matching stage. Each ridge feature vector sequence may further be smoothed and normalized to zero-mean by subtracting its average value from each sample value of the feature vector sequence. The normalization will help matching of ridges with significant differences in signal strength caused by different impressions of the same ridge.

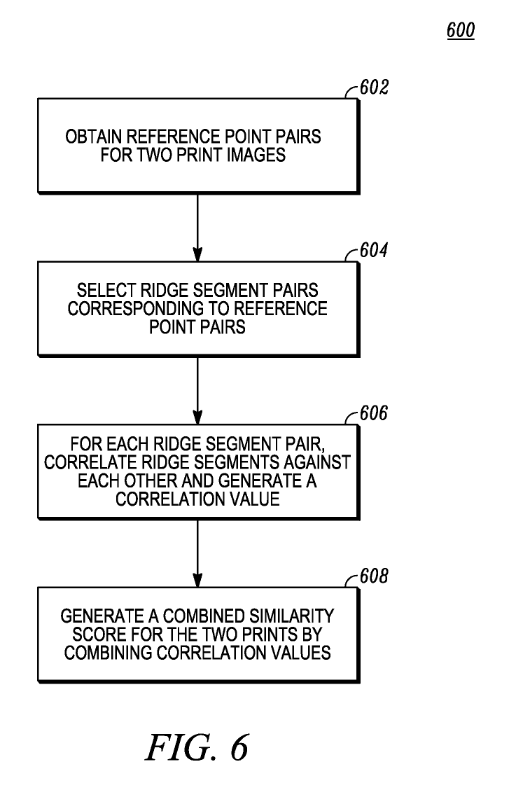

FIG. 6 is a flow diagram illustrating a method 600 for comparing two prints (e.g., fingerprints, palm prints, etc.) using gray level ridge features. The method, generally, comprises the steps of: receiving (602) a first set of reference point pairs between the first and second print images; for at least some of the reference point pairs, selecting (604) at least one corresponding ridge segment pair comprising a first and a second ridge segment, wherein each ridge segment is extracted from a grayscale image guided by at least one binary image, with the segment being extracted along an axis of an elongated shape of a ridge that represents a raised portion of skin; for each ridge segment pair, (606) correlating the first ridge segment against the second ridge segment and generating a corresponding correlation value indicating a level of similarity between the first and second ridge segments; and combining (608) the correlation values to determine a combined similarity score indicating a level of similarity between the first and second print images.

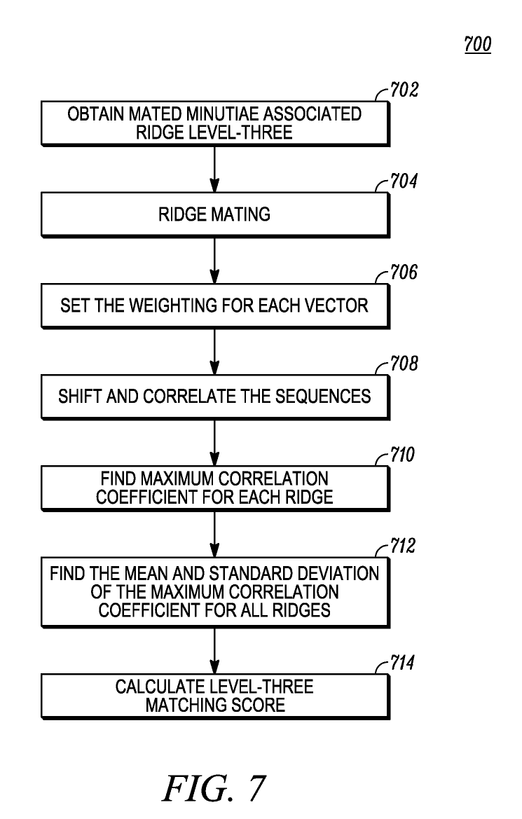

FIG. 7 is a flow diagram of a more detailed method 700 for implementing method 600. For simplicity of illustration, this implementation is in the context of an AFIS, and it uses mated minutiae pairs for the analysis. However, these limitations are only meant to be illustrative and not limitations of the teachings herein. It has been found that regardless of whether the ridge range is based on a fixed-length or a variable length, the length of two matched ridges may be different. Even in the fixed-length case, the natural ridge length for a ridge segment may be less than the desired length due, for instance, to an insufficient number of reference points meeting the quality threshold. Therefore it can be assumed that with level-three ridge matching, two matched ridge feature vector sequences may have different lengths. Moreover using the above ridge feature extraction process, feature extraction begins from a point on the thin ridge ending, which strongly depends on the local gray level characteristics and image processing algorithms. Thus, the thin ridges associated with the same minutia on different prints may start from different physical locations. In consideration of the above, method 700 involves correlation by shifting of two matched segments against each other and partial matching, which enables more reliable matching for feature vectors having a different length.

Turning to the details of method 700, at a step 702 a set of mated minutiae (or generally a set of “matched reference point pairs) is obtained and the corresponding ridge segment pairs (step 704) retrieved from storage. For mated minutiae pairs, the set of mated minutia pairs can be determined using any suitable minutiae matching algorithm. Moreover, for each mated minutia pair, there are three cases to be considered for the ridge matching: Case 1—the mated minutiae are both ridge endings, and the two ridges associated with these two minutiae are natural mates; Case 2—the mated minutiae are both bifurcation, and the ridge mating is performed between the three pairs of feature vector sequences according to storage order as specified in FIG. 5; and Case 3—the mated minutiae are of a different type (one is ridge ending and the other is bifurcation). In this third case, the ridge ending ridge must be the mate of either ridge one or ridge three of the bifurcation. Perform the mating for two pairs: ridge ending ridge and bifurcation ridge one pair, ridge ending ridge and bifurcation ridge three pair.

Optionally, a weighting scheme {Wᵢ, i=0 . . . 4} corresponding to each feature vector element i can be used (step 706). The weighting scheme is useful to put emphasis on one aspect of the level-three features. For example, if it is determined that the ridge curve characteristic represent the most reliable information of the ridge, W₀, which corresponds to curvature, can be set to high value relative to the other weighting values. Whereas, if it is determined that the shape represents the most reliable information of the ridge, W₃ and W₄, which correspond respectively to ridge width and pore width, can be set to higher value. Otherwise if it is considered that the gray level distribution represents the most reliable information of the ridge, W₁ and W₂, which respectively correspond to mean and variance, can be set to higher value.

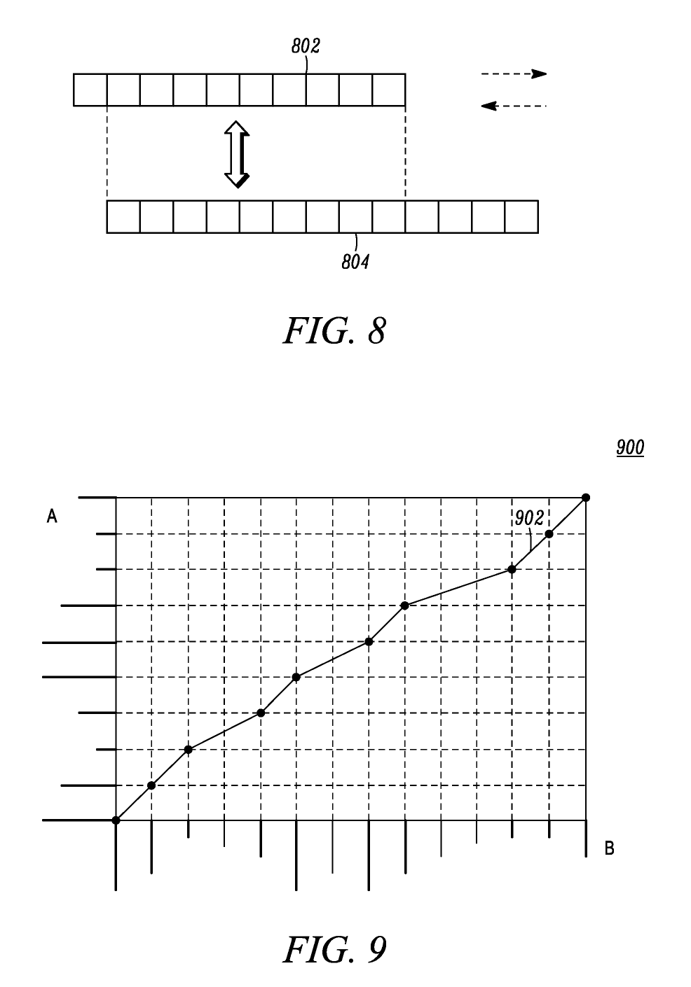

Using the mated ridge segments (e.g., the mated vector sequences), shift and correlate (708) one sequence (e.g., 802 of FIG. 8) to the left and right relative to the other sequence (804). Excluding the points shifted, match the left points (and related values) in this vector sequence with the correspondent points in the other vector sequence and calculate a correlation coefficient Cₗ, indicating a level of similarity between the two sequence vectors associated that shifting of the vector sequences. Any suitable function can be used to determine the correlation coefficients, and these functions are well known in the art, so the details of which are not included here for the sake of brevity. Repeat the shifting step 4 M times (left and right), with M set to be 6 for instance, and calculate a correlation coefficient Cₗ every time, obtaining 2M+1 correlation coefficients {Cᵢ,i=0 . . . 2M). Find (710) the maximum correlation coefficient MCⱼ from {Cᵢ}, where j is the jth mated ridge pair. Calculate (712) the mean Cₘ and standard deviation S_{d} for {MCⱼ}, and (714) a final level three matching score: S=ƒ(Cₘ, S_{d}, M). The final score function ƒ( ) can be chosen to be any appropriate function that is monotonically increasing with respect to Cₘ and monotonically decreasing with respect to S_{d}*M/(M+1).

When the ridge length chosen is quite long, the same ridge on different print impressions may suffer severe deformation. In this situation, the brute-force point-to-point correlation presented above might not yield a reliable result. Instead, an optimization algorithm like dynamic programming can be applied. The idea of dynamic programming is illustrated in FIG. 9, using one dimensional feature vector sequences as an example.

In FIG. 9, a sequence A with ten feature vectors (vertical) and a sequence B with fourteen feature vectors (horizontal) are matched against each other. Due to deformation, there are some feature vectors (thin lines) in B that don't have correspondent feature vectors in A. As shown in FIG. 9, a grid structure (900) can be set up for the matching. Finding the optimal correspondent feature vectors between A and B is equivalent to finding an optimal path 902 going through the grid starting from the left bottom corner to the upper right corner. This optimal path problem is readily solved by the dynamic programming algorithm. The algorithm starts from the assumption that a global optimal path is found by subdividing the path into two parts, and the optimal sub-path in the two parts is selected. This procedure is iteratively performed until the single feature vector level. Generally, some of the signal samples in shorter sequence (A) may not have correspondent signal samples in longer sequence (B) either. In this case, the dynamic programming procedure is the same, except that the A signal samples not having correspondent B signal samples are not included in the final path.

Method 700 implementing the dynamic programming method of correlation is nearly the same as the method discussed above where two sequences are correlated by shifting one against the other, with the exception of the following modifications. Shift the shorter sequences to the left (see FIG. 4) relative to the corresponding longer sequences. Excluding the points shifted, match the left points in shorter ridge with the points in long ridge. Assuming the number of left points is Lᵢ, perform dynamic programming matching of these Li points to the longer ridge points with the number from Lᵢ to Lᵢ+K, with K being determined according to the estimated deformation. For each matching, a correlation coefficient Cⱼ is calculated between optimally correspondent samples determined by dynamic programming. The correlation coefficient for this shift is found as max{Cⱼ}. Repeat this shifting 2 M times and calculate a correlation coefficient Cₗᵢ every time.

The level three feature matching process described above can be implemented in a secondary matcher processor and the final resultant scores fused or combined (e.g., via multiplicatively) with another matcher score such as, for instance, a minutiae matcher score.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for extracting features from a print image comprising the steps of:
obtaining a gray-scale image and at least one binary image;
relative to each of a plurality of reference points, extracting at least one corresponding ridge segment from the gray-scale image guided by the at least one binary image, with the segment being extracted along an axis of an elongated shape of a ridge that represents a raised portion of skin;
determining, using the at least one binary image, a corresponding set of ridge features associated with the extracted ridge segment; and
storing the sets of ridge features to use in comparing the print image to another print image.

2. The method of claim 1, wherein the print image has a resolution of at least one thousand pixels per inch.

3. The method of claim 1, wherein the at least one binary image comprises a wide binary image and a thin image.

4. The method of claim 1, wherein each set of ridge features is based on at least one of:
a pore detected in the gray-scale image;
shape associated with the corresponding extracted ridge segment; and
gray-level distribution associated with the corresponding extracted ridge segment.

5. The method of claim 1, wherein each extracted ridge segment has a length that is one of fixed and variable based on at least one parameter.

6. The method of claim 1, wherein the set of ridge features comprises a sequence of vectors, with each vector in the sequence being associated with a different ridge characteristic and each vector in the sequence comprising a corresponding ridge characteristic value at each of a plurality of selected points on the ridge segment.

7. The method of claim 6, wherein the sequence of vectors comprises;
a first vector comprising a curvature value at each of the plurality of selected points on the ridge segment;
a second vector comprising a mean gray level value at each of the plurality of selected points on the ridge segment;
a third vector comprising a gray level variance value at each of the plurality of selected points on the ridge segment;
a fourth vector comprising a pore width value at each of the plurality of selected points on the ridge segment; and
a fifth vector comprising a ridge width value at each of the plurality of selected points on the ridge segment.

8. The method of claim 1, wherein the method is performed in an Automatic Finger Print Identification System (AFIS).

9. The method of claim 1, wherein the plurality of reference points comprises at least one of a plurality of minutiae detected in the print image, a detected core, a detected delta and a predetermined pixel distance to the plurality of minutiae, the core and the delta.

10. The method of claim 9 further comprising the step of, relative to a detected bifurcation minutiae having a direction:
extracting three corresponding bifurcation ridge segments; and
storing the bifurcation ridge segments in an anti-clockwise directional order starting from the bifurcation ridge segment that is at a first anti-clockwise position of the direction of the bifurcation minutiae.

11. The method of claim 1, wherein the gray scale image is down sampled to a lower resolution to extract the at least one binary image and the reference points, and the at least one binary image and the reference points are up-sampled to an original resolution to determine the set of ridge features.

12. A method for comparing a first print image to a second print image comprising the steps of:
receiving a first set of matched reference point pairs between the first and second print images;
relative to the matched reference point pairs, selecting at least one corresponding ridge segment pair comprising a first and a second ridge segment, wherein each ridge segment is extracted from a grayscale image guided by at least one binary image, with the segment being extracted along an axis of an elongated shape of a ridge that represents a raised portion of skin;
for each ridge segment pair, correlating the first ridge segment against the second ridge segment and generating a corresponding correlation value indicating a level of similarity between the first and second ridge segments; and
combining the correlation values to determine a combined similarity score indicating a level of similarity between the first and second print images.

13. The method of claim 12, wherein the corresponding correlation value for each ridge segment pair is a maximum correlation value generated from the correlating step.

14. The method of claim 12, wherein the matched reference point pairs comprise at least a portion of mated minutiae pairs between the first and second print images.

15. The method of claim 12, wherein correlating step is based on one of shifting the first ridge segment relative to the second ridge segment and a dynamic programming algorithm.

16. The method of claim 12, wherein each ridge segment comprises a sequence of vectors including:
a first vector comprising a curvature value at each of a plurality of selected points on the ridge segment;
a second vector comprising a mean gray level value at each of the plurality of selected points on the ridge segment;
a third vector comprising a gray level variance value at each of the plurality of selected points on the ridge segment;
a fourth vector comprising a pore width value at each of the plurality of selected points on the ridge segment; and
a fifth vector comprising a ridge width value at each of the plurality of selected points on the ridge segment.

17. The method of claim 12, wherein the method is performed in a secondary matcher processor included in an Automatic Fingerprint Identification System (AFIS) and a set of mated minutiae pairs are received from a minutiae matcher processor in the AFIS, which is coupled to the secondary matcher processor.

18. A computer-readable storage element having computer readable code stored thereon for programming a computer to perform a method for processing print image, the method comprising the steps of:
obtaining a gray-scale image and at least one binary image having a lower resolution than the gray-scale image;
relative to at least some of minutiae, extracting at least one corresponding ridge segment from the gray-scale image guided by the at least one binary image, with the segment being extracted along an axis of an elongated shape of a ridge that represents a raised portion of skin;
determining, using the at least one binary image, a corresponding set of ridge features associated with the extracted ridge segment, wherein each set of ridge features is based on at least one of a pore detected in the gray-scale image, shape associated with the corresponding extracted ridge segment, and gray-level distribution associated with the corresponding extracted ridge segment; and
storing the sets of ridge features to use in comparing the print image to another print image.

19. The computer readable storage element of claim 18, wherein the method further comprising the steps of:
receiving a first set of mated minutiae pairs between a first and a second print image;
relative to at least some of the mated minutiae pairs, selecting at least one corresponding ridge segment pair comprising a first and a second ridge segment;
for each ridge segment pair, correlating the first ridge segment against the second ridge segment and generating a maximum corresponding correlation value indicating a maximum level of similarity between the first and second ridge segments; and
combining the correlation values to determine a combined similarity score indicating a level of similarity between the first and second print images.

20. The computer readable storage element of claim 19, wherein each ridge segment comprises a sequence of vectors including:
a first vector comprising a curvature value at each of a plurality of selected points on the ridge segment;
a second vector comprising a mean gray level value at each of the plurality of selected points on the ridge segment;
a third vector comprising a gray level variance value at each of the plurality of selected points on the ridge segment;
a fourth vector comprising a pore width value at each of the plurality of selected points on the ridge segment; and
a fifth vector comprising a ridge width value at each of the plurality of selected points on the ridge segment.
